(19) United States
(12) Patent Application Publication
(10) Pub. No.: US 2007/0165260 A1
(43) Pub. Date: Jul. 19, 2007

(54) Print Driver Pipeline Filter Conformance Validation

(75) Inventor: Mariyan D. Fransazov, Redmond, WA (US)

Correspondence Address: LEE & HAYES PLLC, 421 W RIVERSIDE AVENUE SUITE 500, SPOKANE, WA, 99201, US

(73) Assignee: Microsoft Corporation, Redmond, WA (US)

(21) Appl. No.: 11/470,174

(22) Filed: Sep. 5, 2006

Related U.S. Application Data
(60) Provisional application No. 60/743,138, filed on Jan. 17, 2006.

(51) Int. Cl. G06F 3/12

(52) U.S. Cl. 358/1.13

(57) ABSTRACT

Systems and methods for print driver pipeline filter conformance validation are described. In one aspect, a filter-based print driver processes a spool file to generate a page description language (PDL). The filter-based print driver utilizes multiple process filters to perform the processing. Each process filter implements a particular set of tasks to generate the PDL. One or more validation filters are utilized to automatically validate conformance of data input into and/or output from one or more of the process filters in view of conformance criteria.

### RELATED APPLICATIONS

This patent application claims priority to U.S. provisional application Ser. No. 60/743,138, filed on Jan. 17, 2006, titled “Filter Pipeline Validation”, which is hereby incorporated by reference.

### BACKGROUND

Print devices typically implement a specialized set of commands to perform print operations. A print driver is typically used to translate generic commands received from a program into a compatible set of such specialized commands for the print device. Existing techniques to develop and test print drivers to ensure that they implement functionality that is compatible with specific printer and printer firmware configurations are typically recursive and manually implemented. These testing techniques often involve a human printing test pages with the print driver for visual comparison to a reference page to determine if the test pages represents intended printer output. If difference(s) between test page(s) and the reference page are identified, a software developer typically modifies the print driver to bring the driver's print results closer to that of the reference page. Since existing techniques for print driver testing are manual and dependent upon subjective visual comparisons of rendered output, these techniques are labor-intensive and prone to human error.

### SUMMARY

This summary is provided to introduce a selection of concepts in a simplified form that are further described in the detailed description. This summary is not intended to identify key features or essential features of the claimed subject matter, nor is it intended to be used as an aid in determining the scope of the claimed subject matter.

Systems and methods for print driver pipeline filter conformance validation are described. In one aspect, a filter-based print driver processes a spool file to generate a page description language (PDL). The filter-based print driver utilizes multiple process filters to perform the processing. Each process filter implements a particular set of tasks to generate the PDL. One or more validation filters are utilized to automatically validate conformance of data input into and/or output from one or more of the process filters in view of conformance criteria.

### BRIEF DESCRIPTION OF THE DRAWINGS

FIG. 1 shows an exemplary system for print driver pipeline filter conformance validation, according to one embodiment.

FIG. 2 shows an exemplary procedure for print driver pipeline filter conformance validation, according to one embodiment.

### DETAILED DESCRIPTION

### Overview

Systems and methods for print driver pipeline filter conformance validation are disclosed. A print driver pipeline includes multiple print driver filters (“filters”). Each filter is a pluggable computer-program that implements a respective set of operations associated with print driver processes. The operations that a particular filter implements and the ordering of filters in a pipeline are arbitrary, being a function of the processes that a print driver may perform, architecture of the print driver, and requirements of output device(s) 128. For example, a first filter in a pipeline may read a spool file (print job), a last filter in the pipeline may produce a raster or page description (e.g., PDL) targeted to a particular print device, another filter in-between the first and last filters may perform other functions such as applying a watermark to a document, data format conversions, and/or so on. In this implementation, the filters are interchangeable across different print filter pipelines for use by different print drivers

Use of conventional techniques to validate conformance of a print driver, if applied to a print driver filter pipeline, would not adequately test a print driver filter pipeline. This is because such conventional techniques would merely result in a black-box test (as a whole) of the final output of the print driver pipeline (i.e., only the final output of the last filter in the pipeline could be tested). This conventional approach to testing print drivers does not take into account the configurable, extensible, and modular framework of a print driver filter pipeline.

In contrast to such conventional techniques for testing print drivers, the systems and methods for print driver pipeline filter conformance validation allow testers/developers to automatically validate conformance of individual select ones of multiple self-contained filters in a print driver pipeline to predetermined and respective sets of conformance criteria. These and other aspects of the systems and methods for print driver pipeline filter conformance validation are now described in greater detail.

### An Exemplary System

Although not required, systems and methods for print driver pipeline filter conformance validation are described in the general context of computer-executable instructions (program modules) executed by a computing device such as a personal computer. Program modules generally include routines, programs, objects, components, data structures, etc., that perform particular tasks or implement particular abstract data types. While the systems and methods are described in the foregoing context, acts and operations described hereinafter may also be implemented in hardware.

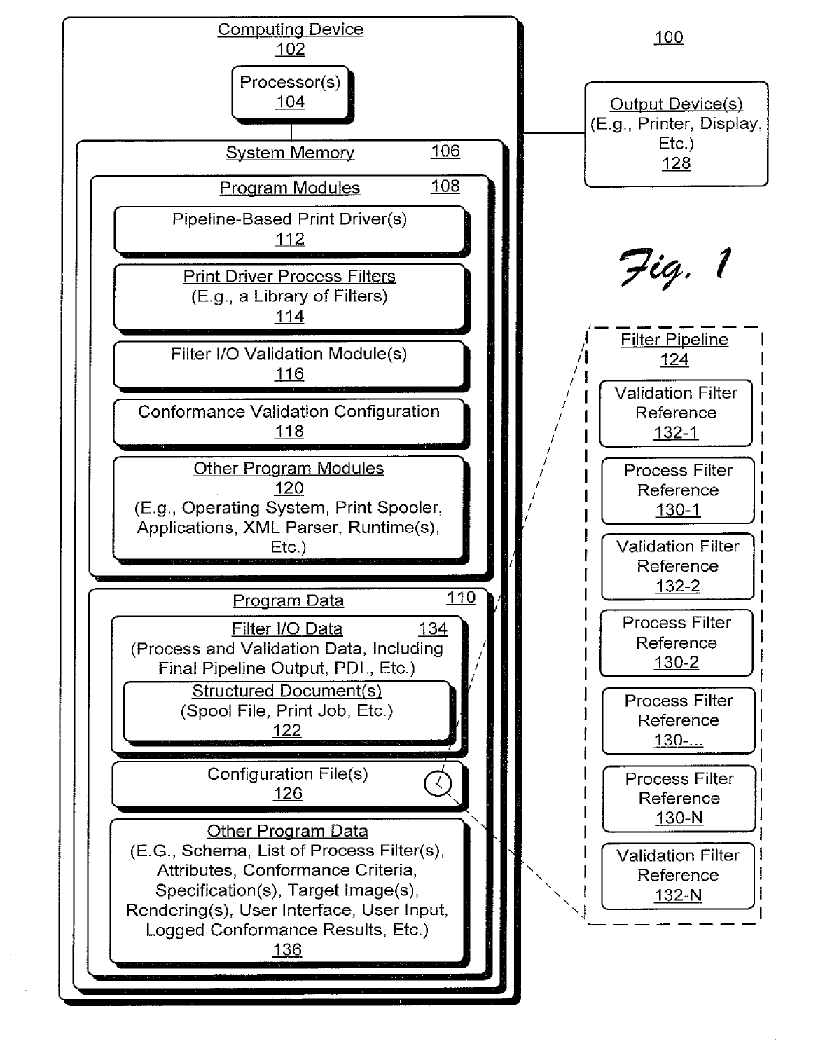

FIG. 1 shows an exemplary system 100 for print driver pipeline filter conformance validation, according to one embodiment. System 100 includes, for example, a computing device 102. Computing device 102 represents any type of computing device such as a general purpose computing device, a server, a laptop, a mobile computer, etc. Computing device 102, for example, includes one or more processors 104 coupled to system memory 106 such as volatile memory (RAM) and non-volatile memory (ROM, Flash etc.). System memory 106 includes program modules 108 and program data 110. Processor(s) 104 fetch and execute computer-program instructions from respective ones of program modules 108. In this implementation, for example, program modules 108 include pipeline-based print driver(s) 112, print driver process filters 114, filter input/output (I/O) validation module(s) 116, conformance validation configuration module 118, and other program modules 120 (e.g., an operating system, a print spooler, one or more applications to use a filter-based print driver 114 to print a document, and/or so on).

Pipeline-based print driver 112 (“driver 112”) processes structured document 122 using a filter pipeline 124 defined by configuration file 126 to generate output for presentation to a user via output device(s) 128. In this implementation, a structured document 122 provides document format, spool file format, and page description language (PDL) for use by print device(s) 128 to print corresponding document content. In this implementation, format of structured document 122 is based on XML Paper Specification (XPS). In another implementation, structured document 122 is based on a different format specification(s) for describing composition of a document to be rendered, visual appearance of each page in the document, and rendering rules for displaying and/or printing the document. Techniques to generate such structured documents 122 are known. In one implementation, configuration file 126 is generated and formatted using a well-know markup language (e.g., XML, etc.) based on a schema that describes structure and content rules for configuration file 126.

Configuration file 126 identifies operational sequence (framework) of pipeline 124 with an ordered set of references 130 (e.g., 130-1 through 130-N) to respective ones of print driver process filters 114 (“process filters 114”), and references 132 (e.g., 132-1 through 132-N) to one or more filter I/O validation modules 116 (“validation modules 116”). Each process filter 114 is a self-contained computer-program application that implements a particular set of print driver 112 operations on respective sets of input data. In one implementation, such input data for a particular process filter 114 represents structured document 122 (unchanged) and/or represents data output from a process filter 114 or validation filter 116 referenced prior in pipeline 124 to the particular filter 114. (Regarding use of the phrase “and/or” in the previous sentence, this means that data output from a process filter 114 or validation filter could still represent an unmodified structured document 122).

Each validation filter 116 referenced by configuration file 126 is a self-contained computer-program application that validates conformance of data targeted for input into select ones of the process filters 114 and/or data output from select ones of the process filters 114. The conformance validation operations are based on arbitrary conformance criteria (specifications, target images, etc.) that are a function of input and/or output data characteristics expected for/from select ones of the referenced process filter(s) 114. In one implementation, data input into a validation filter 116 represents structured document 122 (unchanged) and/or represents other data output from a process filter 114 that was referenced prior to the validation filter in pipeline 130. For purposes of exemplary illustration, process filter 114 and validation filter 116 input data and output data is collectively shown as filter I/O data 134.

Structure of pipeline 130, which is defined by configuration file 126, controls driver 112 order-of-operations. For example, a first reference in pipeline 130 to a validation filter 116 (e.g., reference 132-1), wherein the reference is positioned immediately prior to a second reference to a process filter 114 (e.g., reference 130-1), causes driver 112 to first implement/call/instantiate (etc.) the referenced validation filter 116 to validate conformance of data targeted for input into the process filter 114 associated with the second reference. In this example, the data is evaluated for conformance before the data is actually input by driver 112 into the subsequently referenced process filter 114. Analogously, a reference to a validation filter 116 (e.g., reference 132-2) positioned immediately after a reference to a process filter 114 (e.g., reference 130-1) causes driver 112 to use output from the referenced process filter 114 as input to the subsequently referenced validation filter 116. Such positioning directs driver 112 to validate conformance of the data output from the process filter 114 before the output data is processed by any other entity referenced inside or outside of pipeline 130 (e.g., a different process filter 114, output device 128, etc). In one implementation, a validation filter 116 is verbose in that it notifies a user (e.g., via a log file, message presentation, etc.) of proper and/or improper conformance of filter I/O data 134. In one implementation, such notifications are used for fail/acceptance regression testing of respective ones of process filter(s) 114 and/or driver 112. In one implementation, if a validation filter 116 identifies non-conforming input and/or output data, subsequent operations of defined by pipeline 124 are not implemented.

For purposes of exemplary illustration, conformance criteria (specifications, target images, etc.) used by respective ones of validation filters 116 are shown as respective portions of “other program data” 136. As described, conformance criteria is used to determine conformance of data 134 targeted for input into select ones of process filters 113 and/or conformance of data 134 output from select ones of process filters 114. Since operations of respective process filters 114 are arbitrary, associated filter I/O data 134 conformance criteria is also arbitrary, being functions of input and/or output data characteristics expected from the data being evaluated.

For example, in one implementation, a particular process filter 114 parses a parse a spool file (e.g., structured document 122) according to a specific data format, inserts a watermark into input data, converts a particular PDL to a different PDL, or so on. Considering the example where a process filter 114 parses a spool file according to a specific data format, if the specific data formal, for example, is based on XML Paper Specification (XPS) format, etc.), the conformance criteria is the well-documented format specified by XPS. For instance, and in one implementation, a validation filter 116 implements operations to validate format conformance of filter I/O data 134 to pre-existing package and document conformance criteria as described in U.S. patent application Ser. No. 11/467,497, titled “Automatic Package Conformance Validation”, which was filed Aug. 25, 2006.

In another example, a process filter 114 generates PDL from well-known content, where the PDL is targeted for input to a particular output device 128. Such PDL is shown as a respective portion of filter I/O data 134. To ensure that the PDL is well-formed (such that it would result in a rendering with a desired level of quality by the output device 128), a validation filter 116 implements operations to validate conformance (by some threshold amount) of a rendering of the PDL output from the process filter 114 to a target (idealized) rendering for the well-known content. In one implementation, validation filter 116 implements operations to validate conformance of PDL to result in a target rendering for a print device as described in U.S. patent application Ser. No. 11/466,609, titled “Automated Print Rendering Verification”, which was filed Aug. 23, 2006.

For example, a validation filter 116 communicates process filter 114 generated PDL to a printer (output device 128). In one implementation, responsive to communicating the PDL, validation module 116 receives a rendering of the PDL from the printer. Validation module 116 compares the rendering to a target rendering of the PDL to determine if the rendering complies by some threshold amount to the target rendering. (These operations are implemented independent of whether the printer prints or does not print the printer generated rendering). In another implementation, responsive to communicating the PDL, validation module 116 receives an indication from the printer of whether a rendering of the PDL generated by the printer matches a target rendering of the PDL by some threshold amount. Validation module 116 logs and/or presents results of these operations to a user.

In another example, a particular process filter 114 inserts a watermark into a respective portion of filter I/O data 134. To determine whether the watermark was properly inserted, a validation filter 116 evaluates output from the particular process filter 114 in view of pre-created XPS file and/or raster image conformance criteria. The conformance validation operations may include, for example, XPS comparison checks and/or known fuzzy image comparison techniques.

In one implementation, validation filter 116 does not hardwire a reference to conformance criteria resource(s). Rather, validation filter 116 automatically identifies reference(s) to appropriate conformance criteria resource(s) from information in configuration file 126. Such information includes, for example, input data descriptions/attributes (e.g., data type(s), a link (e.g., a URI) to a specification to use for data conformance determinations, etc.), process filter 114 attributes (e.g., an indication that input and/or output data is to be evaluated in view of a specified set of criteria (markup, binary (non-markup) resource(s), structure, relationships, etc.), attributes associated with the validation filter 116, an indication of how data is passed between respective process filter(s) 114 (i.e., data flow), and/or so on. In another implementation, conformance criteria are specified by a user via command line parameters, responses to a user interface prompts, drop down lists, etc., and/or so on.

Modifying the Configuration File for Pipeline Filter Conformance Validation

In one implementation, configuration file 126 is initially (e.g., by a print driver vendor, or other entity) independent of validation filter(s) 116 to validate conformance of filter I/O data 134 associated with referenced print filters 114. In such a scenario, a user manually or automatically modifies configuration file 134 to insert respective references 132 to select validation filters 116 at appropriate position(s) in pipeline 130 before and/or after references to select ones of the process filters 114. Manual modification of a configuration file 126 can be performed using any known markup editing/viewing application to view and edit a markup document (e.g., an XML editor). Automatic modification of configuration file 126 is now described.

In one implementation, conformance validation configuration module 118 (“configuration module 118”) automatically (i.e., programmatically) facilitates operations to determine conformance of process filters 114 I/O to one or more sets of predetermined I/O criteria. To this end, and in one implementation, configuration module 118 parses configuration file 126 to identify each process filter 114 referenced in a pipeline 124. In one implementation such a reference is a Universal Resource Identifier (URI) identifying a respective filter I/O validation module 116. Along with a list of identified process filters 114, the parsing operations identify a set of conformance criteria attribute(s) associated with each identified filter 114. Such attributes include, for example, one or more of a reference to a specification (e.g., an Open Packaging Convention (OPC) specification, an XPS, and/or so on) to use for input and/or output conformance validation, a reference to a particular filter I/O validation module 116 (e.g., vendor supplied, default, etc.) to use for input and/or output conformance validation, a reference to an existing file or raster image indicating what filter output should represent, and/or so on. Configuration module 118, based on the identified attributes (e.g., including default settings), automatically selects particular validation filter(s) 116 for use to verify conformance of filter I/) data associated with respective ones of the identified process filters 114.

For example, if a first process filter 114 expects to receive an XPS based document as input data, configuration module 118, based on the identified attributes (e.g., including default settings), automatically selects a validation filter(s) 116 (e.g., from a library of validation filters 116) that validates XPS (e.g., markup, structure, relationships, binary resources, etc.) and inserts a reference to that validation filter into the pipeline prior to the reference to the process filter. In one implementation, configuration module 118 also configures the environment such that the selected validation filter 116 will use/access the specific conformance criteria specified by information associated with the process filter 114 that is going to be evaluated for conformance.

In one implementation, a user provides command line parameters and/or responses to a user interface presented by configuration module 118, one or more of:
specific process filters 114 to test,
whether input and/or output from the specific process filters 114 is/are to be validated,
particular validation filters 116 to use for purposes of conformance validation, and
one or more files, images, or other resources representing conformance criteria, etc.

### An Exemplary Procedure

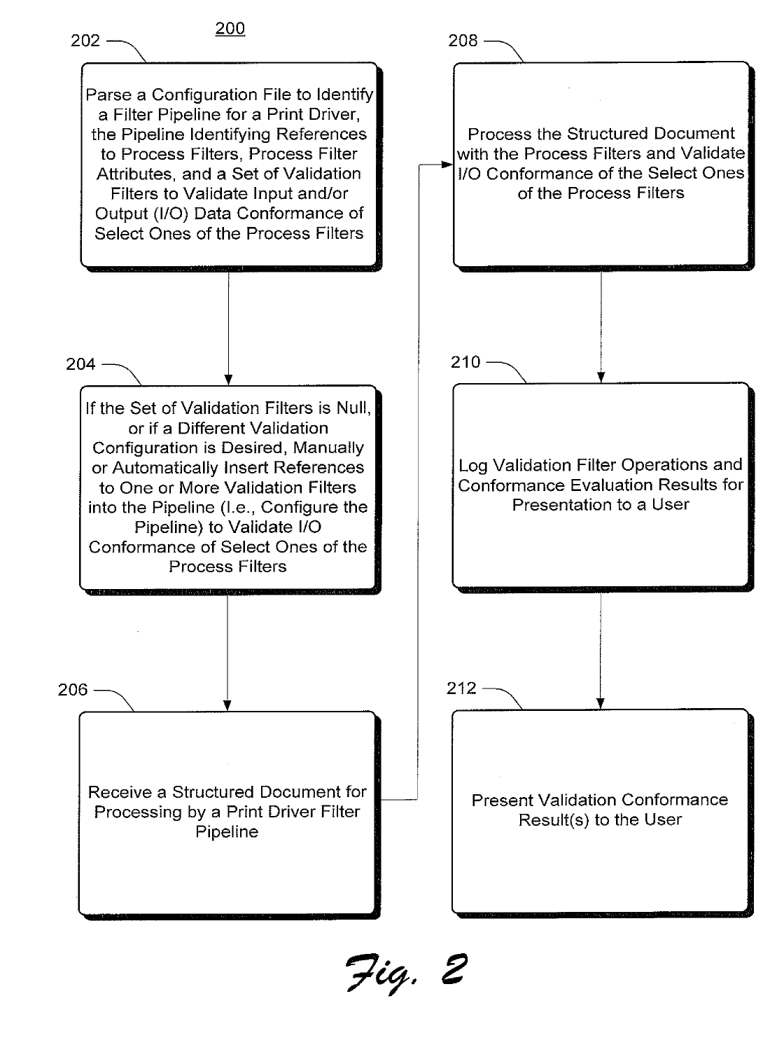

FIG. 2 shows an exemplary procedure 200 for print driver pipeline filter conformance validation, according to one embodiment. For purposes of exemplary description, operations of procedure 200 are described in reference to components and data of FIG. 1. In the description, the leftmost number of a reference number indicates the figure in which the component/data was first introduced. Referring to FIG. 2, operations of block 202 parse a configuration file 126 to identify a filter pipeline 124 for a print driver 112. The filter pipeline 124 includes references 130 to process filters 114 and a set of references 132 to a set (i.e., zero or more) of validation filters 116. The validation filters 116 are for validating input and/or output (filter I/O data 134) of select ones of the process filters 114.

Operations of block 204 determine if the set of validation filters 116 is null. If so, or if a different conformance validation configuration is desired, a user manually or automatically inserts references 132 to one or more validation filters 116 into the pipeline 124 to validate I/O conformance of select ones of the process filters 114. In one implementation, this is accomplished by presenting a user interface to the user to receive user inputs associated with configuring pipeline 124. For purposes of exemplary illustration, such a user interface is shown as a respective portion of “other program data” 136 of FIG. 1. In another implementation, information used to insert references into the pipeline is provided via one or more command line parameters submitted to an application. Such an application utilizes the operations of pipeline-based print driver 112, and is shown as respective portion “other program data” 120.

Operations of block 206 receive a structured document 122 for processing by print driver filter pipeline 124. Operations of block 208 process the received structured document 122 with the referenced process filters 114. During these processing operations, I/O conformance of select ones of the process filters 114 is evaluated by respective ones of the referenced validation filters 116. Operations of block 210 log validation filter operations and conformance evaluation results for presentation to a user. Operations of block 212, present validation conformance results to the user.

### CONCLUSION

Although the systems and methods for print driver pipeline filter conformance validation have been described in language specific to structural features and/or methodological operations or actions, it is understood that the implementations defined in the appended claims are not necessarily limited to the specific features or actions described. Rather, the specific features and operations of system 100 are disclosed as exemplary forms of implementing the claimed subject matter and are not intended to limit the scope of the subject matter disclosed herein.

1. A method at least partially implemented by a computer, the method comprising:
processing, by a filter-based print driver, a spool file to generate a page description language (PDL), the processing being performed by respective ones of multiple process filters, each of the respective ones performing a particular set of tasks to generate the PDL; and
automatically validating, by one or more validation filters, conformance of input and/or output data for each of a select set of the respective ones, the conformance being based on one or more sets of conformance criteria.

2. The method of claim 1, wherein the spool file is a structured document based on an Extensible Markup Language Paper Specification (XPS).

3. The method of claim 1, wherein the PDL is a structured document based on XPS.

4. The method of claim 1, wherein automatically validating further comprises:
parsing the spool file; and
responsive to the parsing, determining whether one or more of structure, markup, and non-markup resources comply with a specification for one or more of structure, markup, and non-markup resources.

5. The method of claim 1, wherein automatically validating further comprises determining whether the PDL results in a target output device rendering with a desired level of quality.

6. The method of claim 5, wherein the determining is performed independent of printing the target output device rendering.

7. The method of claim 1, further comprising:
logging results of operations for automatically validating the conformance; and
presenting the results to a user for fail or acceptance regression testing of the print driver.

8. The method of claim 1, further comprising communicating the PDL to an output device for processing.

9. The method of claim 1, further comprising:
identifying, from a configuration file, a print driver filter pipeline comprising the process filters, input and/or output data flow between respective ones of the process filters, and the conformance criteria; and
wherein the processing is implemented using the print driver filter pipeline.

10. The method of claim 9, further comprising inserting a reference to a validation filter of the one or more validation filters into the print driver filter pipeline before a reference to a process filter of the process filters to configure the filter-based print driver to validate compliance of data designated for input into the process filter.

11. The method of claim 9, further comprising inserting a reference to a validation filter of the one or more validation filters into the print driver filter pipeline after a reference to a process filter of the process filters to configure the filter-based print driver to validate compliance of data output from the process filter.

12. The method of claim 9, further comprising:
parsing the configuration file to identify the select set of process filters; and
automatically inserting a reference to a validation filter of the one or more validation filters into the print driver filter pipeline respectively before and/or after respective references to each of the select set in the configuration file.

13. A computer-readable medium comprising computer-program instructions executable by a processor, the computer-program instructions when executed by the processor performing operations comprising:
configuring a filter-based print driver pipeline to execute multiple process filters and one or more validation filters in a particular order, each process filter being a self contained computer-program that receives respective input data to generate respective output data, each validation filter being a self-contained computer-program to validate conformance of data in view of conformance criteria, the data being designated for input to a particular process filter or output from the particular process filter; and
in the particular order:
processing by respective ones of the process filters, information associated with a structured document; and
automatically validating, by respective ones of the validation filters, conformance of the respective input data and/or the respective output data as part of print driver testing operations.

14. The computer-readable medium of claim 13, wherein the conformance criteria is based on Extensible Markup Language Paper Specification (XPS).

15. The computer-readable medium of claim 13, wherein the conformance criteria is based on a rendering generated by a printer from the respective output data and a target rendering representing an ideal.

16. The computer-readable medium of claim 13, wherein the conformance criteria is based on a determination of whether a watermark was properly inserted into the respective output data.

17. The computer-readable medium of claim 13, wherein configuring the filter-based print driver pipeline to execute the one or more validation filters further comprises:
presenting a user interface to a user; and
receiving information via the user interface from the user to configure the filter-based print driver pipeline to validate conformance of filter I/O data associated with one or more of the process filters;

18. The computer-readable medium of claim 13, wherein the computer-program instructions further comprise instructions for responsive to automatically validating the conformance logging conformance validation results for presentation to a user.

19. A computing device comprising:
a processor; and
a memory coupled to the processor, the memory comprising computer-program instructions executable by the processor, the computer-program instructions when executed by the processor performing operations comprising:
parsing a configuration file to configure a filter-based print driver pipeline designed to execute multiple process filters and one or more validation filters in a particular order, each process filter being a self contained computer-program that receives respective input data to generate respective output data, each validation filter being a self-contained computer-program to validate conformance of data in view of conformance criteria, the data being designated for input to a particular process filter or output from the particular process filter; and
in the particular order:
processing by respective ones of the process filters, information associated with a structured document;
automatically validating, by respective ones of the validation filters, conformance of the respective input data and/or the respective output data as part of print driver testing operations; and
logging conformance validation results for presentation to a user.

20. The computing device of claim 19, further comprising computer-program instructions executable by the processor for performing operations comprising:
inserting a reference to a validation filter of the one or more validation filters into the print driver filter pipeline before a reference to a process filter of the process filters to configure the filter-based print driver to validate compliance of data designated for input into the process filter; and
inserting a reference to a validation filter of the one or more validation filters into the print driver filter pipeline after a reference to a process filter of the process filters to configure the filter-based print driver to validate compliance of data output from the process filter.
